(19) United States
(12) Patent Application Publication
(10) Pub. No.: US 2002/0100043 A1
(43) Pub. Date: Jul. 25, 2002

(54) Content with advertisement information segment

(76) Inventors: Jonathan E. Lowthert, Sunnyvale, CA (US); Oleg Rashkovskiy, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/766,125

(22) Filed: Jan. 19, 2001

(51) Int. Cl. H04N 7/10

(52) U.S. Cl. 725/36; 725/32

(57) ABSTRACT

An apparatus and method for utilizing a first content item in accordance with an info segment which specifies interruption points. At an interruption point, a second content item is utilized. The info segment may prevent certain types of second content items from being utilized, may permit them to be avoided, may control their duration, and other aspects of their utilization. The info segment may specify with which first content item it is associated. The apparatus may include storage and/or retrieval mechanisms for accessing the first and second content items and the info segment.

### Related Applications

This application is related to application Ser. No. ______ and application Ser. No. ______, by these inventors and filed concurrently herewith.

### BACKGROUND OF THE INVENTION

1. Technical Field of the Invention

The present invention relates generally to insertion of advertisements or the like into content such as a movie.

2. Background Art

In present content distribution systems, advertisements are permanently, directly attached to the content with which they are distributed, on the same distribution medium. Rental video tapes typically contain several advertisements at the beginning of the tape, before the movie content begins. In general, the content itself will have a much longer “shelf life” than the advertisements. For example, consider a videotape or DVD copy of a highly successful motion picture, with a commercial at the beginning of the tape or DVD advertising a different movie which had not yet reached theaters at the time the tape was originally released, and which may thereafter have proven to be a complete flop. That videotape or DVD may be rented for dozens of years to come, with the now-pointless advertisement playing each time. As another example, consider a home videotape copy of a Superbowl football game, during which were shown: a commercial for a new model automobile, a commercial for a limited-time home mortgage offer, and a commercial for an after-Christmas furniture sale. Those commercials become useless quickly, in some cases in mere days.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows one embodiment of a system constructed according to the principles of this invention.

FIG. 2 shows one embodiment of a program which includes a content item and an info segment.

FIG. 3 shows the contents of one embodiment of an info segment such as may be used in practicing this invention.

FIG. 4 shows the contents of one embodiment of an ad entry such as may be used in such an info segment.

FIG. 5 shows another embodiment of a program which includes such an info segment used in conjunction with a content item which includes markers.

FIG. 6 shows another embodiment of a program which includes a content item and info segment pointers which point to such an info segment.

FIG. 7 shows an electronic programming guide which includes info segments for the respectively associated content items.

FIG. 8 shows one embodiment of a method for generating an info segment such as that shown in FIG. 3.

FIG. 9 shows one embodiment of a method for generating an ad entry such as that shown in FIG. 4.

FIG. 10 shows one embodiment of a method for operating an ad server such as that shown in FIG. 1.

FIG. 11 shows one embodiment of a method for operating an info segment server such as that shown in FIG. 1.

FIG. 12 shows one embodiment of a method for operating a receiver such as that shown in FIG. 1.

### DETAILED DESCRIPTION

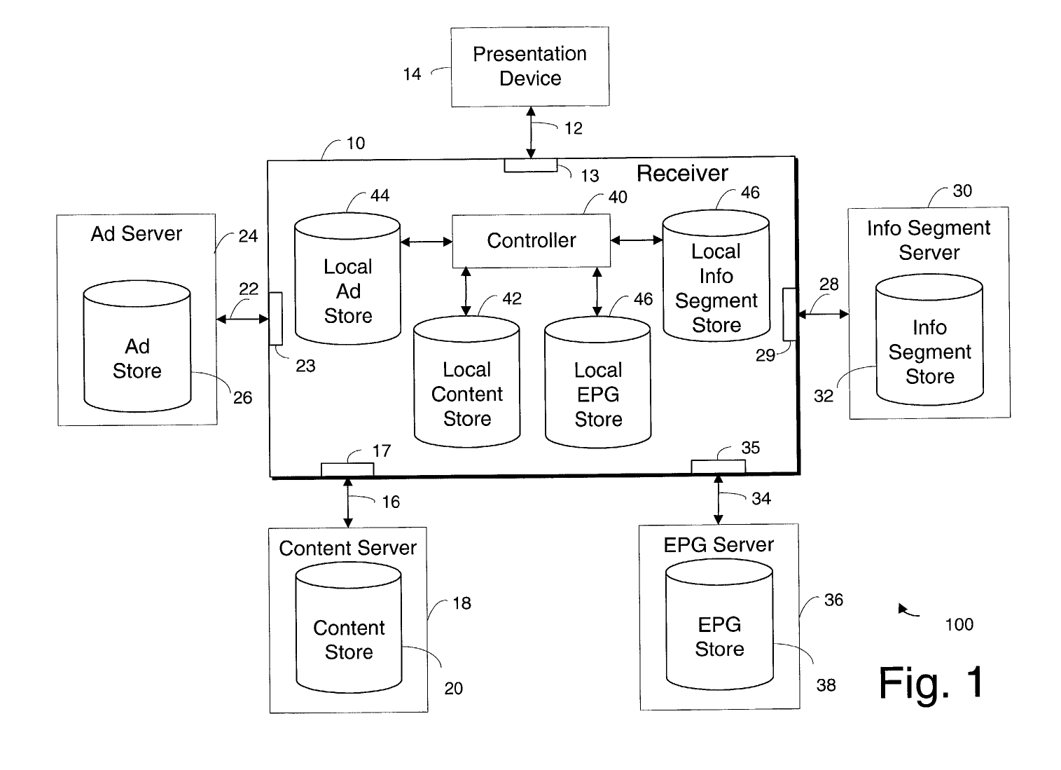

FIG. 1 illustrates one embodiment of a system 5 constructed according to the principles of this invention. The system includes a receiver 10 which is coupled over a presentation link 12 at a presentation device port 13 to a presentation device 14. In various embodiments, the presentation device may be an audio speaker, a video screen, an audio-visual combination device, or other suitable apparatus over which a user may enjoy content such as entertainment programming. The presentation link may be a wire, a wireless connection, an infrared connection, or any other suitable communications mechanism. The port may be any form of suitable connection means.

The receiver is further coupled over a content link 16 at a content port 17 to a content server 18 which includes a content store 20. The content server may be, for example, a television broadcast station, a television cable head-end, a website, a movie production house, or any other producer or provider of user-consumable content, such as entertainment programming, television shows, movies, or the like.

The receiver is also coupled over an ad link 22 at an ad port 23 to an ad server 24 which includes an ad store 26. The ad link, ad server, and ad store will be discussed in terms of storing and delivering advertising content, but the skilled reader will understand that the teachings of this invention may be utilized in providing other types of content which is to interrupt the primary content from the content store. Examples of such other types of content may include digital gift certificates, hyperlinks, links to ATVEF presentations, questionnaires, or other content.

The receiver is further coupled over an info segment link 28 at an info segment port 29 to an info segment server 30 which includes an info segment store 32.

The receiver may also optionally be coupled over an electronic programming guide (EPG) link 34 at an EPG port 35 to an EPG server 36 which includes an EPG store 38.

The content link, ad link, info segment link, and EPG link may each be a wire, a wireless broadcast mechanism, a coaxial cable system, a laser point-to-point link, the internet, a modem, a satellite dish network, a CD-ROM or DVD or the like, “sneakernet”, or other suitable delivery means. They may all be carried on a common link, or each may be a separate and different type of link, or any combination thereof.

The receiver 10 includes a controller 40 which governs the operation of the receiver. To the controller are coupled a local content store 42, a local ad store 44, a local info segment store 46, and an optional local EPG store 48. In some embodiments, these local stores may be constructed as separate storage elements, while in other embodiments, various combinations of them may be constructed to share a common storage element. The storage element(s) may utilize videotape, digital videotape, hard disk, CD-R, CD-RW, DVD-R, semiconductor memory, or any other suitable storage mechanism(s).

Various ones of the various ports and links may, in some embodiments, be internal to the receiver. In some embodiments, there may be more than one of each port and link. In some embodiments, various of the links may be combined.

The phrase “server” is used by way of illustration. The skilled reader will appreciate that the principles of this invention are not limited to a server-client implementation model.

Please make continued reference to FIG. 1 throughout the following explanation.

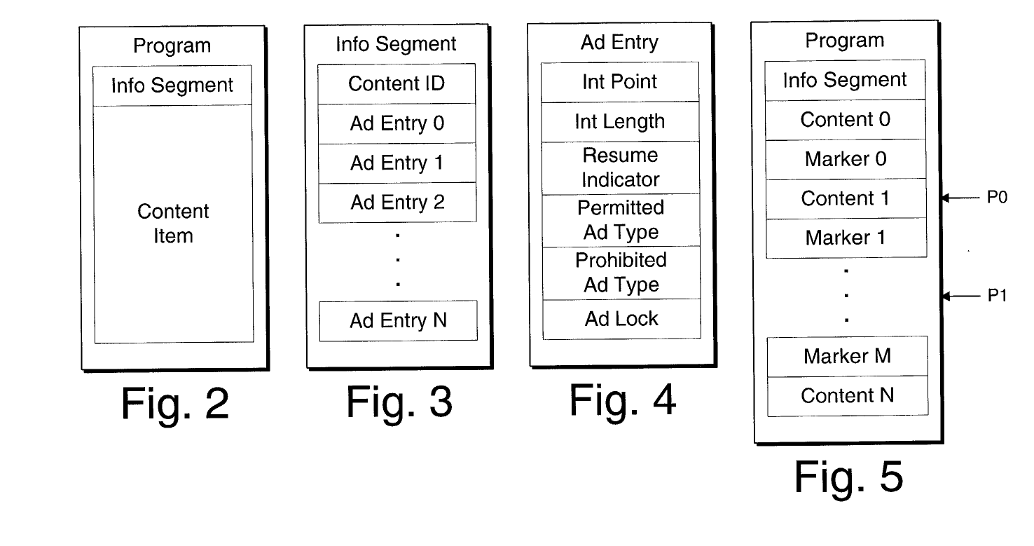

FIG. 2 illustrates one embodiment of a program which includes an info segment and a content item. The info segment is provided to the receiver by the info segment server, and the content item is provided to the receiver by the content server. FIG. 2 may be understood to represent a data stream which contains the info segment and the content item. FIG. 2 may also be understood to represent a recording mechanism upon which are recorded the info segment and the content item. The reader will appreciate that there is not any order implied in the representation, and that the info segment could be recorded or transmitted at the start, at the end, in the middle, in a unitary block, scattered in pieces throughout the content item, as a single instance, as repeated instances, and so forth.

FIG. 3 illustrates one exemplary embodiment of an info segment which may be provided over the info segment link from the info segment server. In some embodiments of the program of FIG. 2, there may be an implicit association between the info segment header and the content item. For example, if the program is provided on a videotape which contains only a single movie—the content item—there will be a single info segment for that movie. In such a case, the content identifier may be regarded as null. The null content identifier may be one that is ignored, or there may simply not be one. In other embodiments, in which the association between the info segment and the content item is not implicit, the info segment will contain a non-null content identifier (Content ID) which specifies with which content item the info segment is associated. In one embodiment, the content identifier may be, for example, a copy of (or a hashed value of) an initial portion of closed caption text in the content item. In another embodiment, the content identifier may be a programming guide reference number of the program, such as a VCR+ number. Other associative mechanisms will be apparent to the reader upon studying this disclosure.

The info segment also contains one or more ad entries (Ad Entry 0-N), which may be stored in any suitable manner, such as a table, a linked list, or the like. The various fields of a given ad entry may be stored contiguously together, or like fields of the multiple ad entries may be stored together.

FIG. 4 illustrates the contents of an exemplary ad entry. In various embodiments, various ones of the fields in an ad entry may be optional, as suitable for the implementation. In some embodiments, the ad entry may contain an interrupt point identification (Int Point) which indicates a point during the content item at which an advertisement should be inserted, interrupting the play of the content item. In some embodiments, play of the content item should be suspended until the advertisement is done. In other embodiments, play of the content item may continue during the advertisement; in such embodiments, the “interruption point” is really an “insertion point”. The interrupt point identification may specify the interruption point in any of a variety of fashions. In one embodiment, it may indicate a time, relative to the start of the content item, at which the ad should be inserted; e.g. “play commercial fifteen minutes into the movie”. In another embodiment, it may indicate a time relative to a most-recently-inserted advertisement; e.g. “play commercial ten minutes after the prior commercial”. In another embodiment, some metric other than time could be used, such as a byte or block count; e.g. “play commercial after one million blocks of the movie have been decoded and played”. In yet another embodiment, the interrupt point identification may specify a content-specific event such as “when the volume goes to zero, play a commercial” or “when there are two consecutive frames of all black, play a commercial” or the like. In yet another embodiment, the interrupt point identification may specify a play-specific factor such as “after the song has been played three times in one month, play a commercial”.

In some embodiments, the ad entry may include an interrupt length (Int Length) specifier of how long the commercial is; e.g. “at this point, insert a thirty-second-long commercial”. A variant of that is “play a commercial, but if it tries to run longer than thirty seconds, cut it off and return to the content”.

In some embodiments, the ad entry may include a resume indicator (Resume Indicator) which may further control the ability of the interrupting advertisement to seize undue control over the playing of the primary content item. One such resume indicator may be, for example, “insert a commercial, but allow the user to override it by hitting the <enter> button on the remote control”. One commercially interesting variant of this might be “insert a commercial, but terminate it if the user hits the <payment> button” upon which some nominal fee may be automatically charged to the user's predetermined account. Fees from such payments could be divided between the content provider and the advertiser.

The ad entry may further include, in some embodiments, a permitted ad type identifier (Permitted Ad Type) and/or a prohibited ad type identifier (Prohibited Ad Type) which, when taken together or alone, may impose limitations upon the type, rating, source, content, or other aspect of advertisement which is allowed by the content provider, the advertiser, and/or the user to be inserted at the specified point. For example, Disney may not want its movies to be interrupted with advertisements which contain nudity. Similarly, Marlboro may wish to prevent its advertisements from being shown during any children's' television program. Or a parent may wish to prevent any advertisements containing profanity, or advertising alcoholic beverages, from being played in their home at any time.

The ad entry may also include additional fields to control various additional aspects of the content/advertisement/audience relationship. As one example, the ad entry may include an ad lock (Ad Lock) field which serves as an override to the interruption by the advertisement. In one embodiment, the ad lock field may be used to cause an advertisement to be played if the user has only rented the videotape, but to skip the advertisement if the user has purchased the videotape. Other uses or heuristics are of course conceivable. For example, the ad lock may permit suppression of the commercial if the time is after ten o'clock at night, or if the user has already viewed twenty-five commercials that day, and so forth.

It is not necessarily required that all ad entries in a given info segment contain exactly the same fields. For example, one ad entry may lack a permitted ad type specifier, while another ad entry in the same info segment may lack an ad lock, while yet another may lack everything but the interrupt point identifier. If it is desired that all ad entries be the same size, then the unused fields may simply be left blank, or they may be filled with some predetermined value indicating non-use. In other embodiments, it may be desirable to minimize the size of the info segment, and, in such cases, it may be suitable to permit ad entries of different sizes, so unused fields do not occupy any bytes.

FIG. 5 illustrates an alternative embodiment of the program, in which the content item is not stored as a contiguous block, but is stored in separate blocks (Content 0-N) between which are interlaced one or more markers (Marker 0-M). In such an embodiment, rather than specifying specific offset times for commercial insertion, the info segment may instead specify that commercials should be inserted at markers. For example, if a viewer tunes in when the content broadcast has already progressed to point P0, the slot (Marker 0) for the first commercial has already passed. Rather than selling “the ad slot at time 15:00 into the broadcast” to the advertiser, it may be desirable to sell “the first ad slot that any given viewer encounters”. In this case, the first commercial will be inserted at the first slot (Marker 1) which this particular viewer encounters, rather than the slot (Marker 0) which has already passed. The reader will appreciate that this business model can be practiced without insertion of such markers; but that markers may be one advantageous embodiment.

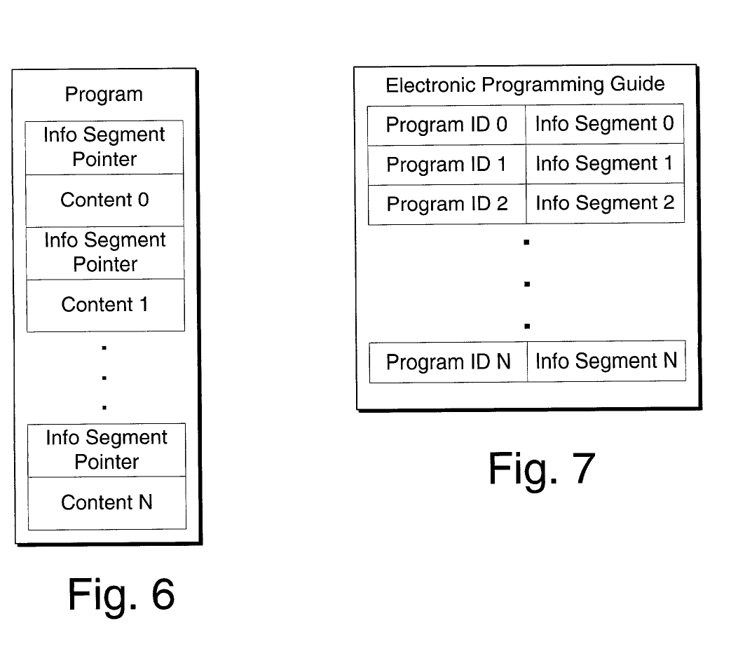

FIG. 6 illustrates another alternative embodiment of the program, in which the info segment is not actually inserted into the program. In the embodiment illustrated by FIG. 5, it was assumed that the info segment had been captured by the receiver, either at the time it was originally broadcast (even though the viewer had not yet tuned in that particular broadcast), or immediately when the viewer tuned in that program. This may not always be practical, in some cases due to the size o the info segment and the limited storage provided in the receiver. As illustrated in FIG. 6, the program may contain info segment pointers (Info Segment Pointer), such as URLs or the like, which take far less bandwidth and storage than the complete info segment. Thus, the pointers may be repeated periodically throughout the broadcast of the content item. The first time the receiver encounters a pointer, it may fetch the info segment.

FIG. 7 illustrates an electronic programming guide (EPG) as modified for use with this invention. The EPG includes one or more program identifiers (Program ID 0-N), each of which provides programming guide information for a particular program, such as channel, start time, ending time, a textual or other listing of its stars and director, and so forth. Associated with each of one or more of the program identifiers is an info segment (Info Segment 0-N) which provides the mapping of advertisements for the associated program.

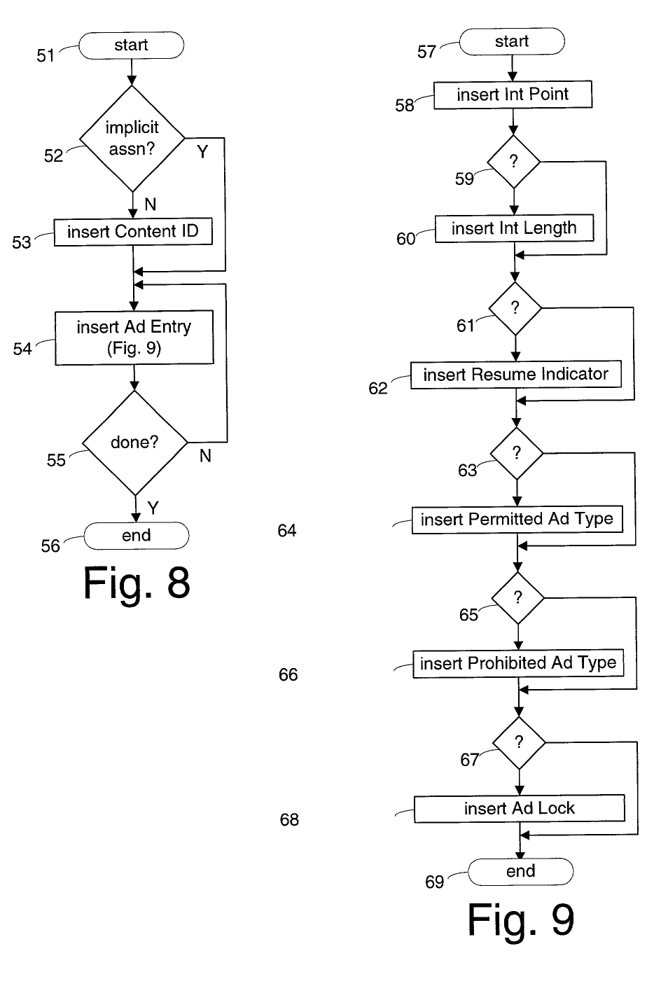

FIG. 8 illustrates one embodiment of a method for generating an info segment, and should be read in conjunction with FIG. 3. The method begins at a starting point (51). If (52) there is an implicit association between the info segment and the content item to which it pertains, then the method may optionally skip the insertion (53) of the content identifier (Content ID). Then, the method inserts (54) at least one ad entry (Ad Entry 0). If (55) there are more ad entries to be inserted, then the method iterates through the insertion (54) of the ad entries until there are no more to be inserted. Then the method is finished (56). The reader will appreciate that an info segment may be ordered, structured, formatted, protected, encrypted, compressed, and so forth, according to the needs of the application.

FIG. 9 illustrates one embodiment of a method for generating an ad entry, and should be read in conjunction with FIG. 4. The method shown in FIG. 9 may be utilized to perform the insertion of the ad entry, in FIG. 8. The method begins at a starting point (57). In embodiments where it is required, the method inserts (58) an interrupt point identification (Int Point). If (59) it is required, the method inserts (60) an interrupt length specifier. If (61) it is required, the method inserts (62) a resume indicator. If (63) it is required, the method inserts (64) a permitted ad type identifier. If (65) it is required, the method inserts (66) a prohibited ad type identifier. If (67) it is required, the method inserts (68) an ad lock. Finally, the method ends (69). The reader will appreciate that an ad entry may be ordered, structured, formatted, protected, encrypted, compressed, and so forth, according to the needs of the application.

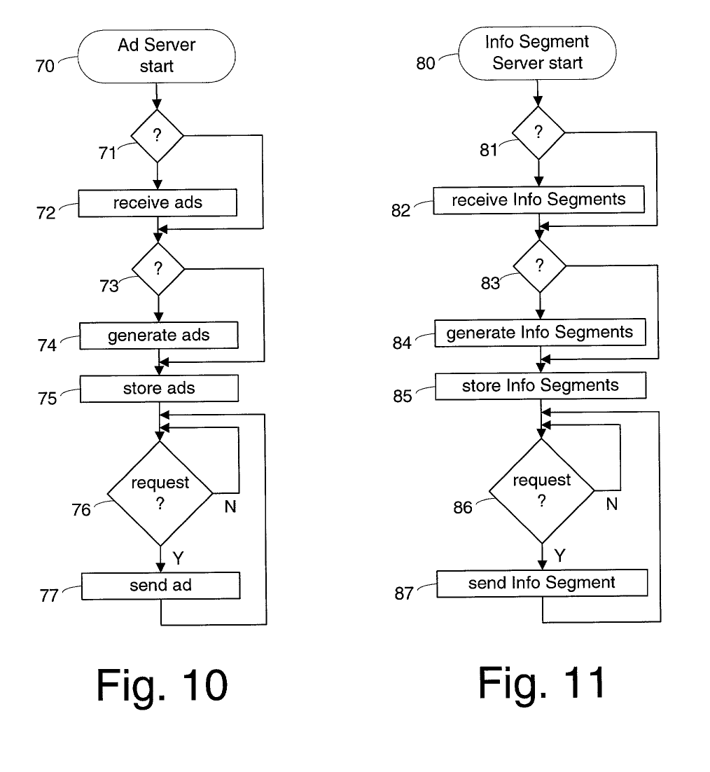

FIG. 10 illustrates one embodiment of a method for operating an Ad Server such as that shown in FIG. 1. The method begins at a starting point (70). The ad server may optionally (71) receive ads (72) from external sources. The ad server may also optionally (73) generate ads (74) itself. The ad server stores the ads in an ad store. In a “pull” model, the ad server waits (76) for requests for ads, then retrieves those ads from the ad store (or it could even generate or fetch them on the fly), and sends the ads (77) to the requester over an ad link. The ad server then returns to wait for additional requests. In a “push” model, the ad server would not wait for requests, but would proactively deliver ads without waiting for requests.

FIG. 11 illustrates one embodiment of a method for operating an Info Segment Server such as that shown in FIG. 1. The method begins at a starting point (80). The info segment server may optionally (81) receive info segments (82) from external sources. The info segment server may also optionally (83) generate info segments (84) itself. The info segment server stores the info segments in an info segment store. In a “pull” model, the info segment server waits (86) for requests for info segments, then retrieves those info segments from the info segment store (or it could even generate or fetch them on the fly), and sends the info segments (77) to the requester over an info segment link. The info segment server then returns to wait for additional requests. In a “push” model, the info segment server would not wait for requests, but would proactively deliver info segments without waiting for requests.

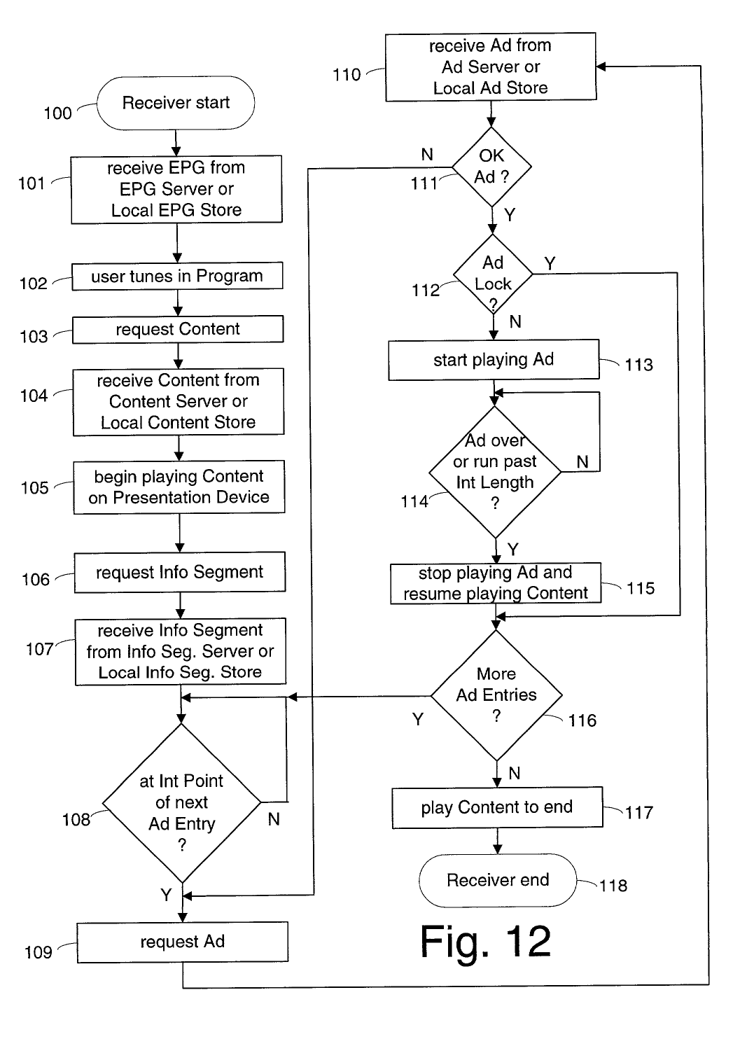

FIG. 12 illustrates one embodiment of a method for operating a Receiver such as that shown in FIG. 1, to which the reader should refer. The method begins at a starting point (100). The Receiver may receive (101) an electronic programming guide (EPG) from an EPG Server, or from the Local EPG Store if it has previously been received and cached. This may be done in the background, without direct user input. The user tunes in (102) a program, or the Receiver may do this automatically, such as if the user has programmed the Receiver to always tune in a particular program. The Receiver requests (103) content for that program, and then receives (104) the content from the Content Server or from the Local Content Store if it has previously been received and cached. The Receiver begins to play (105) the content on the Presentation Device. The Receiver requests (106) an info segment for that program, and receives (107) the info segment from the Info Segment Server, or from the Local Info Segment Store if it has previously been received and cached;

in that case, it may then also check to see if the locally stored info segment is still valid or current.

During play of the content, the receiver waits (108) until play reaches the first interruption point identified in the info segment. At that point, the receiver requests (109) an ad, and receives (110) the ad from the Ad Server or from the Local Ad Store if the ad has previously been received and cached. If (111) the ad and content do not, together, meet the criteria specified by the Permitted Ad Type and Prohibited Ad Type specifiers, the Receiver requests (109) another ad. If (112) the Ad Lock indicator says to this ad may not be skipped, or the requisite conditions are met for skipping the ad, then the Receiver interrupts play of the content and begins (113) playing the ad instead. If (114) the ad runs longer than permitted by the Int Length specifier, or the ad ends, the Receiver stops (115) playing the ad and resumes playing the content. If (116) there are more ad entries, control returns to wait for the next interruption point (108). If (112) the Ad Lock indicator permits the ad to be skipped, and if the requisite conditions are met, no ad will be played, and the method will check (116) if there are more ad entries; in such a case, it may be that the Receiver should play the already-retrieved ad rather than fetching a new one, at the next interruption point. Ultimately, the content is played (117) to its end and the method finishes (118).

The reader should appreciate that FIGS. 8-12 each represents both a process for performing a respective method, as well as a recordable medium or other instruction delivery mechanism in which is encoded or recorded or otherwise represented a series of instructions, routines, firmware, or control codes or the like which, when executed by a computer device or loaded as firmware or control codes into a programmable hardware device or provided as inputs to a runtime interpreter or the like, cause such hardware or software to perform the respective method. The reader should also appreciate that FIGS. 2-7 each represents both a respective data entity and a recordable medium or other data delivery mechanism in which is encoded or recorded or otherwise represented that data entity. Instruction and data delivery mechanisms (and the various links described above) include, but are not limited to: magnetic tape, optical discs, DVD, DVD-R, DVD-RW, CD, CD-ROM, CD-R, CD-RW, floppy disk, hard drive, removable hard drive, semiconductor memory device, and the like, as well as down-the-wire, over-the-airwaves, wireless packet, cable television signal, laser-carried, internet protocol delivery, and other such forms of delivery mechanism.

The reader should appreciate that, while the invention has been described with reference to the interruption of a first content item for the playing of a second content item which has been described above as being an advertisement, it is not necessary that the second content be a commercial advertisement. The invention may be used in interrupting any type of first content item for the play of any type of second content item. The content items may be video, audio, audio/video, text, or any other suitable form of data. The receiver may, in some embodiments, contain an integral presentation device. In others, the presentation device may be external. The invention may readily be utilized in a wide variety of applications; for example, the receiver may be a DVD player, a CD player, a video player, an audio player, an e-book viewer, or any other suitable device.

Finally, the reader should appreciate that in various embodiments of the system, various of the servers' functions may be performed by a single, combined entity. For example, the ad server and the info segment server could be a single server, or the content server and the info segment server could be built as a single entity, or all four servers could share a common platform, and so forth.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An apparatus for receiving data from servers over links and for providing the data to a presentation device, the apparatus comprising:
an info segment port for coupling to a first of the links to receive thereover an info segment;
a content port for coupling to a second of the links to receive thereover a content item;
an ad port for coupling to a third of the links to receive thereover an advertisement; and
a controller, coupled to the info segment port, the content port, and the ad port, the controller being adapted to provide the content item to the presentation device until the info segment indicates an ad insertion point, and to then provide the advertisement to the presentation device.

2. The apparatus of claim 1 further comprising:
a local ad store coupled to the controller and the ad port to cache the advertisement between the advertisement being received and being provided to the presentation device.

3. The apparatus of claim 2 further comprising:
a local info segment store coupled to the controller and the info segment port to cache the info segment.

4. The apparatus of claim 3 further comprising:
a local content store coupled to the controller and the content port for caching the content item between the content item being received and being provided to the presentation device.

5. The apparatus of claim 1 wherein at least two of the info segment link, the content link, and the ad link are a same physical link mechanism, and wherein:
the corresponding two of the info segment port, the content port, and the ad port are a same physical port.

6. The apparatus of claim 5 wherein the info segment link, the content link, and the ad link are a same physical link mechanism, and wherein:
the info segment port, the content port, and the ad port are a same physical port.

7. The apparatus of claim 1 wherein a particular content item includes a content item identifier, wherein the info segment includes (i) a content identifier, and (ii) at least one ad entry each of which specifies an ad insertion point, and wherein the apparatus further comprises:
means, in the controller, for comparing the content identifier of the info segment to the content item identifier to determine whether the info segment is associated with the received content item; and
means, responsive to the means for comparing, for interrupting play of the content item at the ad insertion point specified by the at least one ad entry if the info segment is associated with the received content item.

8. The apparatus of claim 7 wherein the at least one ad entry each further specifies an ad type, and wherein the apparatus further comprises:
means, in the controller, for determining whether the received ad meets a criterion of the specified ad type, and if the ad does not, for retrieving another ad which does; and
means, responsive to the means for determining, for playing the ad which meets the criterion of the specified ad type.

9. The apparatus of claim 8 wherein the means for determining whether the received ad meets the criterion of the specified ad type comprises:
means for determining whether the received ad is of a type allowed to be played during an interruption of the content item.

10. The apparatus of claim 8 wherein the means for determining whether the received ad meets the criterion of the specified ad type comprises:
means for determining whether the content item is of a type during which the received ad is allowed to be played.

11. The apparatus of claim 1 wherein at least one of the links is an external link.

12. The apparatus of claim 1 wherein at least one of the links is an internal link.

13. The apparatus of claim 1 further comprising the presentation device integral to the apparatus.

14. The apparatus of claim 1 wherein the controller is further adapted to continue providing the content item to the presentation device after the advertisement.

15. The apparatus of claim 1 wherein the apparatus comprises a DVD player.

16. The apparatus of claim 1 wherein the apparatus comprises a music player.

17. The apparatus of claim 1 wherein the apparatus comprises an e-book viewer.

18. A method comprising:
receiving a first content item of a program;
receiving at least one second content item;
receiving an info segment of the program, the info segment including at least one entry, each entry specifying an interruption point for insertion of a second content item;
playing the first content item to an interruption point specified by the at least one entry;
interrupting play of the first content item;
playing the second content item; and
returning to play of the first content item.

19. The method of claim 18 further comprising:
in response to either the receiving of the program or the playing of the first content item, requesting the info segment.

20. The method of claim 19 wherein the interruption point is a specified time into play of the content item, and wherein the method further comprises:
the specified time into play, after beginning play of the first content item, interrupting play of the first content item.

21. The method of claim 20 wherein the interruption point indicates an amount of time from a point at which play of the first content item actually begins, rather than from a beginning of the first content item.

22. The method of claim 18 wherein the at least one entry further specifies a maximum interruption length, and the method further comprises:
if the second content item has not finished playing, the specified maximum interruption length after it started playing, halting play of the second content item and returning to play of the first content item.

23. The method of claim 18 wherein the info segment includes a plurality of entries, and the method further comprises:
after returning to play of the first content item, waiting for a next interruption point specified by a next one of the plurality of entries.

24. The method of claim 18 wherein the first content item is a television show or a movie, and the second content item is a commercial advertisement.

25. The method of claim 18 further comprising, prior to tuning in the program:
requesting the second content item; and
caching the second content item in a local store;
wherein the playing of the second content item includes retrieving the second content item from the local store.

26. The method of claim 25 further comprising:
requesting a plurality of second content items; and
caching the plurality of second content items in a local store;
wherein the playing of the second content item includes,
selecting from the cached plurality of second content items one second content item which meets a criterion specified in the entry, and
retrieving from the local store the selected one second content item.

27. The method of claim 18 further comprising:
the entry further specifying a lock condition; and
if the lock condition is met, skipping the interrupting of play of the first content item and the playing of the second content item.

28. The method of claim 27 wherein:
the lock condition comprises the condition of whether the first content item has been purchased or rented, and the lock condition is met if the first content item has been purchased.

29. The method of claim 18 wherein the info segment includes a value which associates the info segment with the first content item.

30. The method of claim 18 wherein the info segment is delivered with the first content item and is implicitly associated therewith.

31. A video disc player comprising:
means for playing a video content item from a video disc;
means for storing one or more interruption points;
means, coupled to the means for storing and means for playing, for interrupting play of the video content item at one of the one or more interruption points; and
means for playing a second content item when play of the video content item is interrupted by the means for interrupting.

32. The video disc player of claim 31 further comprising:
means for retrieving the second content item from an external server.

33. The video disc player of claim 31 further comprising:
means for storing the second content item.

34. The video disc player of claim 31 further comprising:
means for resuming play of the video content item after play of the second content item.

35. The video disc player of claim 31 further comprising:
means for limiting play of the second content item.

36. The video disc player of claim 35 wherein the means for limiting play of the second content item comprises:
means for defeating the means for interrupting.

37. The video disc player of claim 35 wherein the means for limiting play of the second content item comprises:
means for avoiding play of some second content items based on their content.

38. The video disc player of claim 35 wherein the means for limiting play of the second content item comprises:
means for halting play of the second content item after a predetermined amount of time.

39. An audio player comprising:
means for playing a first audio content item;
means for storing one or more interruption points;
means for interrupting play of the audio content item at the one or more interruption points;
means for playing a second audio content item during interruption of play of the first audio content item; and
means for resuming play of the first audio content item after play of the second audio content item.

40. The audio player of claim 39 further comprising:
means for storing a plurality of the second audio content items.

41. The audio player of claim 39 further comprising:
means for altering play of the second audio content item.

42. The audio player of claim 41 wherein the means for altering play of the second audio content item comprises:
means for avoiding the interruption of the first audio content item upon a condition.

43. The audio player of claim 42 wherein the condition is that the first audio content item has been paid for.

44. The audio player of claim 41 wherein the means for altering play of the second audio content item comprises:
means for avoiding play of second content items which do not meet a criterion.

45. The audio player of claim 44 wherein the criterion is based on a rating of content of the second content item.

46. The audio player of claim 41 wherein the means for altering play of the second audio content item comprises:
means for resuming play of the first audio content item after a predetermined period of time regardless of whether the second audio content item has played to completion.

47. An e-book viewer comprising:
means for accessing an e-book;
means for accessing one or more interruption points;
means, coupled to the means for accessing the e-book, for viewing the e-book;
means, coupled to the means for viewing and the means for accessing the one or more interruption points, for viewing alternative content at the interruption points.

48. The e-book viewer of claim 47 further comprising:
means for altering functionality of the means for viewing alternative content in response to a criterion.

49. The e-book viewer of claim 48 wherein the criterion is whether payment has been made for the e-book, the alternative content comprises a commercial advertisement, and the means for altering comprises means for avoiding play of the commercial advertisement.

50. The e-book viewer of claim 47 wherein the means for accessing the interruption points further comprises means for accessing one or more alternative content control specifiers for the one or more interruption points.

51. The e-book viewer of claim 50 wherein the one or more alternative content control specifiers are selected from the group comprising:
a specifier of a permitted alternative content item type;
a specifier of a prohibited alternative content item type;
a specifier of a maximum interruption duration;
a resume specifier; and
a lock specifier.

52. A computer comprising:
first storage adapted to store a first content item;
second storage adapted to store a second content item;
third storage adapted to store a plurality of interruption points;
means for utilizing the first content item; and
means for interrupting utilization of the first content item at the plurality of interruption points; and
means for utilizing the second content item upon interrupted utilization of the first content item.

53. The computer of claim 52 further comprising:
the third storage being further adapted to store at least one control specifier for each of the plurality of interruption points; and
means for altering interruption of the first content item responsive to at least one such control specifier.

54. The computer of claim 53 wherein the at least one control specifier comprises a prohibited second content item type specifier.

55. The computer of claim 54 wherein the at least one control specifier further comprises a maximum interruption duration specifier.

56. The computer of claim 54 further comprising:
means for associating the plurality of interruption points with the first content item.

57. A video game apparatus adapted to play a video game, the video game apparatus comprising:
means for storing one or more interruption points; means for interrupting play of the video game at the one or more interruption points; and
means for displaying an advertisement during interruption of play of the video game.

58. The video game apparatus of claim 57 further comprising:
means for associating the interruption points with the video game.

59. The video game apparatus of claim 57 further comprising:
means for storing a plurality of control specifiers; and
means for altering interruption of play of the video game in response to at least one of the plurality of control specifiers.

60. The video game apparatus of claim 59 wherein:
the control specifiers include a prohibited ad type specifier; and
the means for altering interruption prevents the means for displaying from displaying an advertisement of a type specified by the prohibited ad type specifier.

61. The video game apparatus of claim 59 wherein:
the control specifiers include an ad lock specifier; and
the means for altering interruption prevents interruption if payment has been made for play of the video game and the ad lock specifier permits prevention of interruption.
